(19) United States
(12) Patent Application Publication
(10) Pub. No.: US 2015/0324953 A1
(43) Pub. Date: Nov. 12, 2015

(54) METHOD AND APPARATUS FOR PERFORMING SINGLE-IMAGE SUPER-RESOLUTION

(71) Applicant: THOMSON LICENSING, Issy-les-Moulineaux (FR)

(72) Inventors: Jordi SALVADOR MARCOS, Hamburg (DE); Eduardo FEREZ PELLITERO, Hannover (DE); Axel KOCHALE, Springe (DE)

(73) Assignee: THOMAS LICENSING

(21) Appl. No.: 14/762,202

(22) PCT Filed: Jan. 14, 2014
(86) PCT No.: PCT/EP2014/050617

§ 371 Date: Jul. 20, 2015

(30) Foreign Application Priority Data
Jan. 24, 2013 (EP) 13305085.6

(51) Int. Cl. G06T 3/40; G06K 9/66; G06K 9/00; G06T 5/20

(52) U.S. Cl. CPC G06T 3/4053; G06T 5/20; G06K 9/66; G06K 9/00536; G06T 3/4007; G06T 2207/20081

(57) ABSTRACT

In a method for performing super-resolution of a single image, a high-resolution version of an observed image is generated by exploiting cross-scale self-similarity, wherein up-scaling and analysis filters are used. The up-scaling and analysis filters are adaptively selected according to local kernel cost.

### FIELD OF THE INVENTION

This invention relates to a method for performing single-image super-resolution, and an apparatus for performing single-image super-resolution.

### BACKGROUND OF THE INVENTION

First efforts in Super-Resolution (SR) focused on classical multi-image reconstruction-based techniques [1,2]. In this approach, different observations of the same scene captured with sub-pixel displacements are combined to generate a super-resolved image. This constrains its applicability to very simple types of motion between captured images, since registration needs to be done, and is typically unsuitable for up-scaling frames in most video sequences. It also degrades fast whenever the magnification factor is large [3,4] or the number of available images is insufficient.

The SR research community has overcome some of these limitations by exploring the so called Single-Image Super Resolution (SISR). This alternative provides many possible solutions to the ill-posed problem of estimating a high-resolution (HR) version of a single input low-resolution (LR) image by introducing different kinds of prior information.

One common approach in SISR is based on machine learning techniques, which aim to learn the relation between LR and HR images, usually at a patch level, using a training set of HR images from which the LR versions are computed [5,6, 7]. Thus, performance will be closely related to the content of the training information. To increase the generalization capability, the training set needs to be enlarged, resulting in a growing computational cost. When considering all possible image scenarios (ranging e.g. from animals to circuitry), finding a generalizable training set can then be unfeasible. Current research on sparse representation [8] tackles this problem by representing image patches as a sparse linear combination of base patches from an optimal over-complete dictionary. Even though with sparse representation the dictionary size is drastically reduced and so the querying times, the execution time of the whole method is still lengthy. In addition, the cost of finding the sparse representation is still conditioned by the size of the training dataset. Thus, there might still be generalization issues.

There also exist methods with internal learning (i.e. the patch correspondences/examples are obtained from the input image itself) which exploit the cross-scale self-similarity property [9,10].

### SUMMARY OF THE INVENTION

The present invention follows this strategy, aiming at a better execution time vs. quality trade-off. In principle, when performing super-resolution of a single image, this comprises generating a high-resolution version of an observed image by exploiting cross-scale self-similarity. According to the invention, a low-frequency band of the super-resolved image is interpolated, and the missing high-frequency band is estimated by combining high-frequency examples extracted from the input image. Then it is added to the interpolated low-frequency band. Further according to the invention, adaptively selected up-scaling and analysis filters are used, e.g. for local error measurement. In particular, the up-scaling and analysis filters provide a range of parametric kernels with different levels of selectivity, among which the most suitable ones are adaptively selected. More selective filters provide a good texture reconstruction in the super-resolved image, whereas filters with small selectivity avoiding ringing, but tend to miss texture details.

In one embodiment, the invention uses internal learning, followed by adaptive filter selection, which leads to better generalization to the non-stationary statistics of real-world images.

Advantages of the invention are visible in view of quantitative results (PSNR, SSIM and execution time) as well as qualitative evidence that support the validity of the proposed approach in comparison to two well-known state-of-the-art SISR methods, obtained with different datasets. These results show that the proposed method is orders of magnitude faster than the known comparison SISR methods [8,11], while the visual quality of the super-resolved images is comparable to that of the internal learning SISR method [11] and slightly superior to that of the dictionary-based SISR method [8]. The latter is affected by the limited generalization capability problem.

### BRIEF DESCRIPTION OF THE DRAWINGS

Exemplary embodiments of the invention are described with reference to the accompanying drawings, which show in

FIG. 1 effects of filter (hₛ) selection (2× magnification);

FIG. 2 an exemplary image and corresponding adaptive filter selection;

FIG. 3 histograms of selected filters;

FIG. 4 Y-PSNR vs. time and SSIM vs. time for the Kodak and Berkeley datasets;

FIG. 5 the original images used for demonstration;

FIG. 6 sample results from both the Kodak and Berkeley datasets obtained with the proposed method;

FIG. 7 a flow-chart of a method for performing super-resolution processing;

FIG. 8 synthesis of the high-frequency band of the super-resolved image by extrapolation of the high-frequency information of similar patches at the original resolution scale;

FIG. 9 exemplary usage and positions of a search window;

FIG. 10 selection of successive patches in a 2D input data structure, including overlap, and the principle of determining a matching block for successive patches; and

FIG. 11 an apparatus for performing super-resolution processing.

### DETAILED DESCRIPTION OF THE INVENTION

The present invention relates to a new method for estimating a high-resolution version of an observed image by exploiting cross-scale self-similarity. The inventors extend prior work [14] on single-image super-resolution by introducing an adaptive selection of the best fitting up-scaling and analysis filters for example learning. This selection is based on local error measurements obtained by using each filter with every image patch, and contrasts with the common approach of a constant metric in both dictionary-based and internal learning super-resolution.

The invention is interesting for interactive applications, offering low computational load and parallelizable design that allows e.g. straight-forward GPU implementations. The invention can be applied for digital input data structures of various different dimensions (i.e. 1D, 2D or 3D), including digital 2D images. Experimental results show how the disclosed method and apparatus of the invention generalize better to different datasets than dictionary-based up-scaling, and comparably to internal learning with adaptive post-processing.

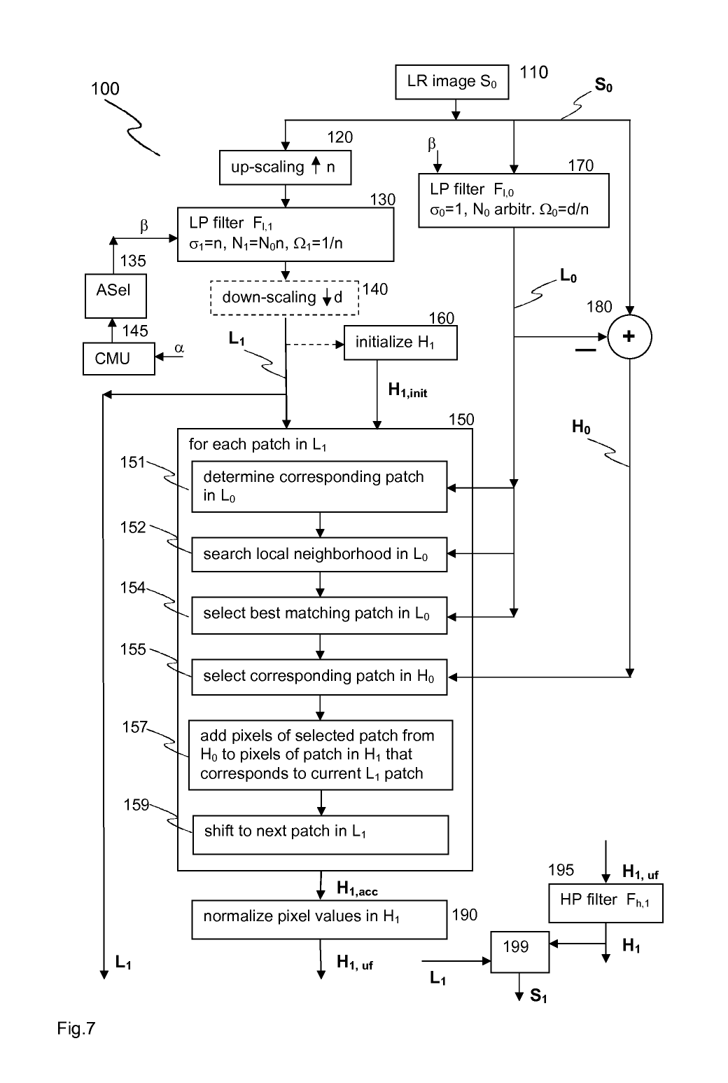

In principle, the method for generating a super-resolution version of a single low resolution digital input data structure S₀ according to the present invention works as follows (cf. FIG. 7). The method comprises steps of upscaling and low-pass filtering the single low resolution digital input data structure to obtain a low-frequency portion L₁ of an upscaled high resolution data structure, and separating the low resolution digital input data structure S₀ into a low-frequency portion L₀ and a high-frequency portion H₀. A high-frequency portion H_{1,init} of the upscaled high resolution data structure is created, which is initially empty. Then, for each of a plurality of patches of the low-frequency portion L₁ of the upscaled high resolution data structure, a best matching block in the low-frequency portion L₀ of the low resolution digital input data structure is searched, and its corresponding block in the high-frequency portion H₀ of the low resolution digital input data structure is determined. The determined block from the high-frequency portion H₀ of the low resolution digital input data structure is then added to the high-frequency portion H_{1,acc} of the upscaled high resolution data structure, at the position that the above-mentioned patch in the low-frequency portion L₁ of the upscaled high resolution data structure has. Finally, the resulting high-frequency portion H_{1,acc} of the upscaled high resolution data structure is normalized and high-pass filtered. The high-pass filtered, normalized high-frequency portion H₁ of the upscaled high resolution data structure is added to the low-frequency portion L₁ of the upscaled high resolution data structure, which results in an improved super-resolution version S₁ of the single low resolution digital input data structure S₀. In the step of upscaling and low-pass filtering the single low resolution digital input data structure S₀, and in the step of separating the low resolution digital input data structure S₀ into a low-frequency portion L₀ and a high-frequency portion H₀, adaptively selected filters are used.

When using interpolation-based up-scaling methods, the resulting HR image presents a frequency spectrum with shrunk support. Interpolation does not provide any mechanism to fill in the missing high-frequency band up to the wider Nyquist limit for the up-scaled image. In the method and apparatus according to the invention, the missing high frequency band is estimated by combining high-frequency examples extracted from the input image and added to the interpolated low-frequency band, based on a similar mechanism to the one introduced in [12]. As known from [9], most images present the cross-scale self-similarity property. This basically results in a high probability of finding very similar patches across different scales of the same image. Let xₗ=hₛ*(y↑s) be an up-scaled version of the input image y, with hₛ a linear interpolation kernel and s the up-scaling factor. The subscript l refers to the fact this up-scaled image only contains the low-frequency band of the spectrum (with normalized bandwidth 1/s). For now, it will just be assumed that hₛ has a low-pass filter behavior. More details about the filter will be given below.

The input image y can be analyzed in two separate bands by using the same interpolation kernel used for up-scaling. The low-frequency yₗ=hₛ*y and high-frequency yₕ=y−yₗ bands can be computed. By doing so, pairs of low-frequency references (in yₗ) and their corresponding high-frequency examples (in yₕ) are generated. yₗ has the same normalized bandwidth as xₗ and, most importantly, the cross-scale self-similarity property is also present between these two images.

Let x_{l,i} be a patch with dimensions Nₚ×Nₚ pixels with the central pixel in a location λ(x_{l,i})=(rᵢ, cᵢ) within xₗ. We look for the best matching patch in the low-resolution low-frequency band y_{l,j}=argmin_{y}_{_{l,j}}∥y_{l,j}−x_{l,i}∥₁, whose location is λ(y_{l,i}) (note that ∥x∥p=(Σᵢ₌₁ⁿ∥xᵢ∥^{P})^{1/P} is the P-norm of a patch with n pixels). This is also the location of the high-frequency example y_{h,j} corresponding to the low-frequency patch of minimal cost. This search is constrained to a window of size N_{w}×N_{w} pixels around λ(x_{l,i})/s, assuming it is more likely to find a suitable example in a location close to the original one than further away [12].

The local estimate of the high-frequency band corresponding to a patch is just x_{h,i}=y_{h,j}. However, in order to ensure continuity and also to reduce the contribution of inconsistent high-frequency examples, the patch selection is done with a sliding window, which means up to Nₚ×Nₚ high-frequency estimates are available for each pixel location λᵢ. Let eᵢ, be a vector with these n≦Nₚ×Nₚ high-frequency examples and 1 an all-ones vector. We can find the estimated high-frequency pixel as xᵢ=argminₓ_{ᵢ}∥eᵢ−xᵢ1∥₂², which results in xᵢ=Σⱼ₌₁ⁿe_{i,j}/n. It is noted that different norms might also be considered.

Once the procedure above is applied for each pixel in the up-scaled image, the resulting high-frequency band xₕ might contain low-frequency spectral components, since (1) filters are not ideal and (2) the operations leading to xₕ are nonlinear. Thus, in order to improve the spectral compatibility between xₗ and xₕ, the low-frequency spectral component is subtracted from xₕ before adding it to the low-frequency band x:=xₗ+xₕ−hₛ*xₕ to generate the reconstructed image.

### Filter Selection

FIG. 1 shows effects of filter (hₛ) selection for a magnification factor of 2. In (a), a very selective filter provides detailed texture in the super-resolved image but also produces ringing. In (b), a filter with small selectivity reduces ringing but fails to reconstruct texture. In (c), texture is reconstructed with reduced ringing by locally selecting a suitable filter. FIGS. 1 (a) and (b) show how the proposed method behaves when considering different designs for the interpolation kernel (or low-pass filters) hₛ. Overall, the choice of a selective filter provides a good texture reconstruction in the super-resolved image, whereas filters with small selectivity tend to miss texture details with the advantage of avoiding ringing. This results from the non-stationary nature of image statistics, and encourages us to locally select the most suitable filter type for each region in the image. FIG. 1 (c) shows how this strategy allows to reconstruct texture in areas with small contrast and avoids ringing in regions with high contrast (e.g. around edges).

In one embodiment, a raised cosine filter [13] is chosen to provide a range of parametric kernels with different levels of selectivity. The analytic expression of a one-dimensional raised cosine filter is

$${h}_{s , β} ( t ) = \frac{sin ( π st )}{π st} \frac{cos ( π s β t )}{1 - 4 {s}^{2} {β}^{2} {t}^{2}} \qquad ( 1 )$$

where s is the up-scaling factor (the bandwidth of the filter is 1/s) and β is the roll-off factor (which measures the excess bandwidth of the filter). Since all the up-scaling and low-pass filtering operations are separable, this expression is applied for both vertical and horizontal axis consecutively. The value of β is enforced to lie in the range [0, s−1], so that the excess bandwidth never exceeds the Nyquist frequency. With β=0, the most selective filter (with a large amount of ringing) is obtained, and with β=s−1 the least selective one.

In order to adaptively select the most suitable filter from a bank of five filters with

$$β = \{ 0 , \frac{s - 1}{4} , \frac{s - 1}{2} , 3 \frac{s - 1}{4} , s - 1 \} ,$$

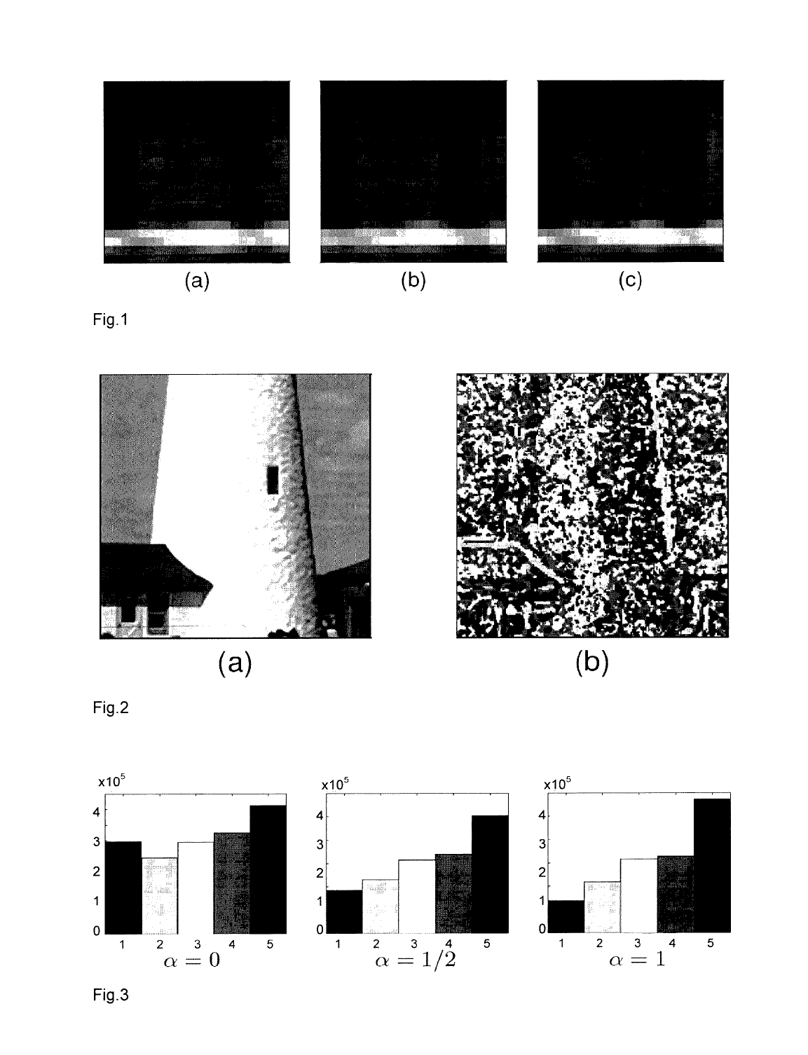

we look for the one providing minimal matching cost for each overlapping patch, as introduced below. FIG. 2 shows the result of an exemplary adaptive filter selection. On the left-hand side, a part of a super-resolved image (2× magnification) is shown. On the right-hand side, it is shown for each pixel which of different filters from a set of five raised cosine filters with β={0, ¼, ½, ¼, 1} is selected. The statistical distribution of the filter selection is related to the non-stationary statistics of the image. In other words, FIG. 2 shows, greyscale encoded, the chosen filter for each patch, ranging from light for 13=0, through

$$β = \frac{s - 1}{4} , β = \frac{s - 1}{2} and β = 3 \frac{s - 1}{4}$$

to dark for β=s−1. That is, for pixels shown at the lightest grey level, a filter with a roll-off factor β=0 and high selectivity was adaptively selected. For pixels shown at the next darker grey level, a filter with a higher roll-off factor β=s−1/4 and lower selectivity was adaptively selected, etc.

The used nomenclature is: x_{β,l,i}, x_{β,h,i}, Y_{β,l,i} and y_{β,h,i} denote (in this order) a low-frequency patch, the corresponding reconstructed high-frequency patch, the best matching low-resolution reference patch and its corresponding high-frequency example patch, respectively, which have been obtained by using the interpolation kernel and analysis filter h_{s,β}. Then, the local kernel cost is measured as

k_{β,i}=α∥x_{β,l,i}−y_{β,l,j}∥₁+(1−α)∥x_{β,h,i}−y_{β,h,i}∥₁ (2)

A parameter α is suitable for tuning the filter selection. FIG. 3 shows histograms of selected filters (for 2× magnification) from a set of five raised cosine filters with β={0, ¼, ½, ¾, 1} (left to right) for different values of the tuning parameter α. The greyscale mapping is the same as in FIG. 2(b). As shown in FIG. 3, smaller values of a (ignoring low-frequency differences) tend to a more uniform selection of filters, whereas larger values of α (ignoring high-frequency differences) typically result in the selection of ringing-free filters, with worse separation of low-frequency and high-frequency bands. In tests, larger values of a tend to yield qualitatively and objectively better results. The final super-resolved image is obtained by averaging the overlapping patches of the images computed with the selected filters, as described further below.

The proposed method has been implemented in MATLAB, with the costlier sections (example search, composition stages, filtering) implemented in OpenCL without special emphasis on optimization. The patch size is set to Nₚ=3 and the search window size to N_{w}=15. The algorithm is applied iteratively with smaller up-scaling steps (s=s₁ s₂ . . . ), e.g. an up-scaling with s=2 is implemented as an initial up-scaling with s₁=4/3 and a second one with s₂=3/2.

Even though the proposed method can also compute the magnification with a single step, the wider bandwidth available for matching with smaller magnification factors results in better selection of high-frequency examples, at the cost of a somewhat increased computational cost. As a post-processing stage, we apply Iterative Back-Propagation (IBP) [1] to ensure the information of the input image is completely contained in the super-resolved one:

x⁽ⁿ⁺¹⁾:=x⁽ⁿ⁾+hᵤ*((y−((x⁽ⁿ⁾*h_{d})↓s)↑s) (3)

The algorithm converges typically after 4 or 5 iterations. The up-scaling (hᵤ) and down-scaling (h_{d}) kernels are the ones used for bi-cubic resizing.

FIG. 7 shows an exemplary flow-chart of a method for performing super-resolution processing of a low resolution input data structure (S₀) of digital 1D, 2D or 3D data. In this embodiment, the method comprises steps of filtering 170 the input data structure S₀ by a first low-pass filter F_{l,0}, wherein a low-frequency input data structure L₀ is obtained,

calculating in an adder/subtractor 180 a difference between the input data structure S₀ and the low-frequency input data structure L₀, whereby a high-frequency input data structure H₀ is generated,
upscaling 120 the input data structure S₀, and filtering 130 the upscaled input data structure by a second low-pass filter F_{l,1}, wherein a low-frequency upscaled data structure L₁ is obtained,
determining in the low-frequency upscaled data structure L₁ a first patch P_{n,L1} at a first position,
searching 152,154 in the low-frequency input data structure L₀ a first block B_{n,L0} that matches the first patch P_{n,L1} best, and determining the position of said first block B_{n,L0} within the low-frequency input data structure L₀,
selecting 155 a second block B_{n,H0} in the high-frequency input data structure H₀ at the determined position,
accumulating 157 pixel data of the selected second block B_{n,H0} to a second patch P_{n,H1}, the second patch being a patch in a high-frequency upscaled data structure H_{1,acc} at the first position,
repeating 150 the steps of determining a new patch P_{n,L1} in the low-frequency upscaled data structure L₁, searching 152,154 in the low-frequency input data structure L₀ a block B_{n,L0} that matches the selected patch P_{n,L1} best, selecting 155 a corresponding block B_{n,H0} in the high-frequency input data structure H₀ and
accumulating 157 pixel data of the selected corresponding block B_{n,H0} to a patch P_{n,H1} in the high-frequency upscaled data structure H_{1,acc} at the position of said new patch P_{n,L1}, and
normalizing 190 the accumulated pixel values in the high-frequency upscaled data structure H_{1,acc}, whereby a normalized high-frequency upscaled data structure H₁ is obtained. Finally, a super-resolved data structure S₁ is obtained by adding the normalized high-frequency upscaled data structure H₁ to the low-frequency upscaled data structure L₁. The filters that are adaptively selected according to the present invention are the low-pass filters 130,170, i.e. the first low-pass filter F_{l,0} and the second low-pass filter F_{l,1}. For these filters, one out of two or more raised cosine filters according to eq. (1) is selected in an adaptive selection step 135 (with the same parameter β for both filters), as controlled by a cost measuring step 145. The cost measuring step can be tuned by a parameter α, as described above. In implementations, different parameterized variants of these filters (with different β) can be available simultaneously, or as a single variable filter.

In some embodiments, the upscaled input data structure after filtering 130 by the second low-pass filter F_{l,1} is downscaled 140 by a downscaling factor d, with n>d. Thus, a total non-integer upscaling factor n/d is obtained for the low-frequency upscaled data structure L₁. The high-frequency upscaled data structure H_{1,init} (or H₁ respectively) has the same size as the low-frequency upscaled data structure L₁. The size of H₁ may be pre-defined, or derived from L₁. H₁ is initialized in an initialization step 160 to an empty data structure H_{1,init} of this size.

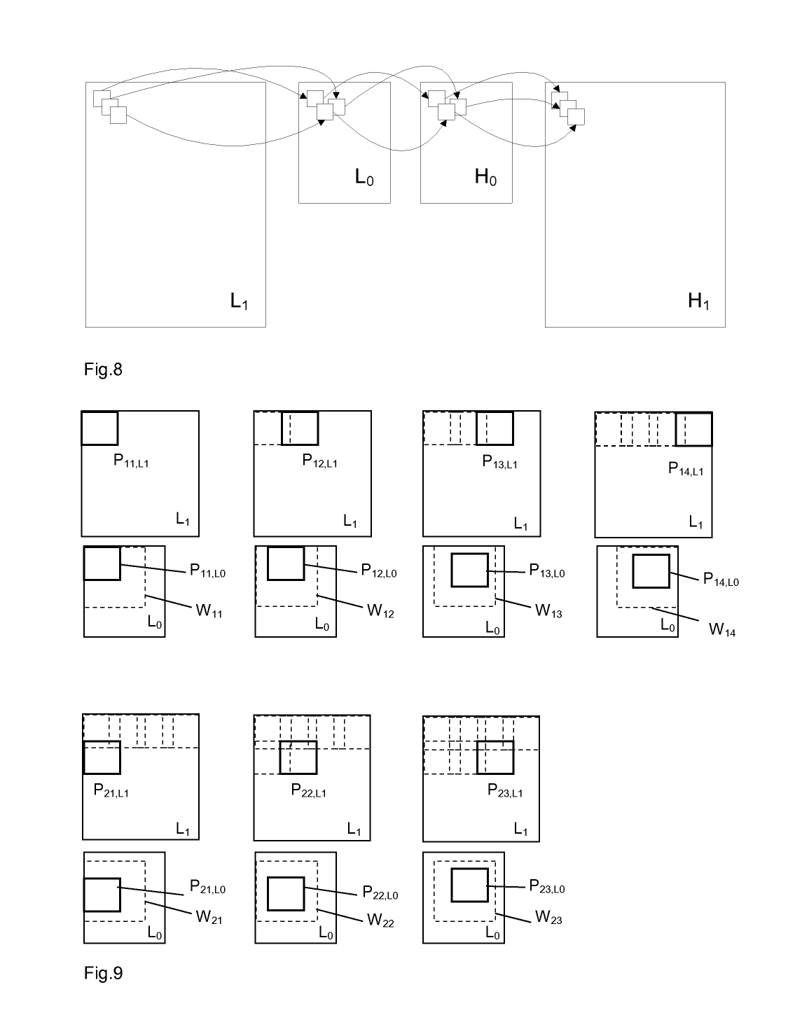

FIG. 8 shows the principle of the synthesis of the high-frequency band H₁ of a super-resolved (i.e. high resolution) image by extrapolation of the high-frequency information of similar patches at the original resolution scale H₀. Note that, if in the following description the high-frequency high-resolution data structure H₁ is mentioned, actually the non-normalized high-frequency high-resolution data structure H_{1,acc} is meant.

The low-frequency band of the high-resolution image L₁ is first divided into small patches P_{n,L1} (e.g. 5×5 or 3×3 pixels) with a certain overlap. The choice of the amount of overlap trades-off robustness to high-frequency artifacts (in the case of more overlap) and computation speed (in the case of less overlap). In one embodiment, an overlap of 20-30% in a each direction is selected, i.e. for adjacent patches with e.g. 5 values, 2 values overlap, and for adjacent patches with 3 values, 1 or 2 values overlap. In other embodiments, the overlap is higher, e.g. 30-40%, 40-50% or around 50% (e.g. 45-55%). For an overlap below 20% of the patch size, the below-described effect of the invention is usually lower.

The final high-frequency band H₁ is obtained after normalizing by the number of patches contributing to each pixel, thus resulting in an average value. It is clear that the larger the overlap between patches, the better the suppression of high-frequency artifacts resulting from the high-frequency extrapolation process.

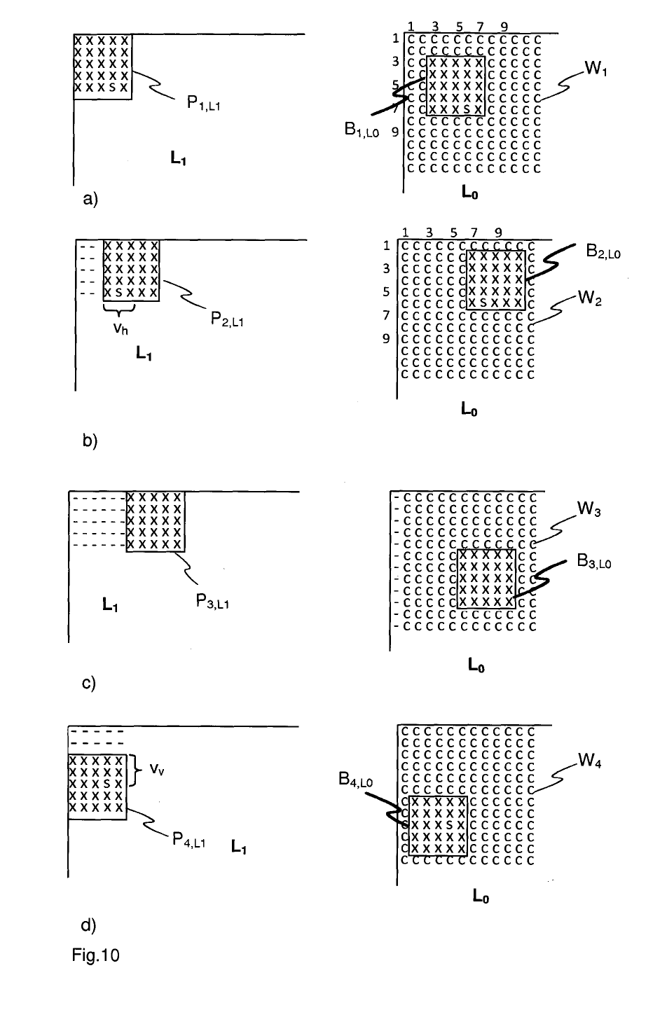

Then, for each low-frequency high-resolution patch P_{n,L1}, a best match in terms of mean absolute difference (MAD) is obtained after an exhaustive search in a local search window (e.g. 11×11 pixels) over the low-frequency band L₀ of the low-resolution image. The best match is a block P_{n,L0} from the low-frequency high-resolution image L₀ that has the same size as the low-frequency high-resolution patch P_{n,L1} (e.g. 3×3 or 5×5 pixels). More details about the search window are described below with respect to FIG. 10.

For understanding the next step, it is important to note that the low-resolution low-frequency data structure L₀ has the same dimension as the low-resolution high-frequency data structure H₀, and the high-resolution low-frequency data structure L₁ has the same dimension as the high-resolution high-frequency data structure H₁. as shown in FIG. 8. For every patch, the position of the matched low-frequency low-resolution patch P_{n,L0} (within L₀) is determined, and the corresponding low-resolution high-frequency patch P_{n,H0} (within H₀) at the position of the matched low-frequency low-resolution patch P_{n,L0} is extracted. The extracted low-resolution high-frequency patch P_{n,H0} from H₀ is then accumulated on the high-frequency band of the high-resolution image H₁, at the same position that the current patch in the high-resolution low-frequency data structure L₁ has. In detail, each value (e.g. pixel) of the extracted low-resolution high-frequency patch P_{n,H0} from H₀ is accumulated on the corresponding value (e.g. pixel) in the respective patch of the high-frequency band of the high-resolution image H₁. In this way, the high-frequency band of the high-resolution image H₁ is synthesized by patch-wise accumulation. The process of dividing the low-frequency band of the high-resolution image L₁ in overlapping patches, finding the best low-frequency match and accumulating the corresponding high-frequency contribution is illustrated in FIG. 9.

As a result, each value in the resulting (preliminary) high-frequency band of the high-resolution data structure H₁ is a sum of values from a plurality of contributing patches. Due to the patch overlap in L₁ (and consequently also in H₁ since both have the same dimension), values from at least two patches contribute to many or all values in H₁. Therefore, the resulting (preliminary) high-frequency band of the high-resolution data structure H₁ is normalized 190. For this purpose, the number of contributing values from H₀ for each value in the high-frequency high resolution data structure H₁ is counted during the synthesis process, and each accumulated value in H₁ is divided by the number of contributions.

FIG. 9 shows, exemplary, usage and positioning of a search window within the low-resolution low-frequency data structure L₀. For a first patch P_{11,L1} in L₁, a first best matching block P_{11,L0} is searched in L₀ within a first search window W₁₁. Both patches have the same size. The search window is larger than the patch by at least one value in each direction (except on edges, as for the first patch). In this example, the first best matching block P_{11,L0} is found in L₀ in the upper left corner of the first search window W₁₁. The further process for this patch and block is as described above. Then, subsequent patches are shifted horizontally and/or vertically, wherein each patch overlaps a previous patch.

In the example, a second patch P_{12,L1} is selected at a position that is shifted horizontally by a given patch advance. Patch advance is the difference between patch size and overlap. Patch advances in different dimensions (e.g. horizontal and vertical for 2D data structures) may differ, which may lead to different effects or qualities in the dimensions of the high-resolution output data structure, but they are usually equal. A new search window W₁₂ is determined according to the new patch position. In principle, the search windows advance in the same direction as the patch, but slower. Thus, a current search window may be at the same position as a previous search window, as is the case here. However, since another patch P_{12,L1} is searched in the search window, the position of the best matching patch P_{12,L0} will usually be different. The best matching patch P_{12,L0} is then accumulated to the high-resolution high-frequency data structure H₁ at the position of the low-frequency high-resolution patch P_{12,L1}, as described above. Subsequent patches P_{13,L1}, P_{14,L1} are determined and searched in the same way. As shown in FIG. 9, the position of the best matching block in the search window is arbitrary and depends on the input data (e.g. the image content).

The above description is sufficient at least for 1-dimensional (1D) data structures. For 2D data structures, the position of a further subsequent patch is found by vertical patch advance (this may or may not be combined with a horizontal patch advance). Also vertical patch advance includes an overlap, as mentioned above and also shown in FIG. 9.

The position of the search window is determined according to the position of the current patch. As shown in FIG. 9, the search windows W₁₁, . . . , W₂₂ of different patches overlap. Since L₀ is a smaller data structure than L₁, the search window advance in each dimension is very small. In one embodiment, the search windows are on the edge of L₀ if their corresponding patch is on an edge of L₁, and it is uniformly or proportionally moved in between these edges.

In one embodiment (not shown in FIG. 9), the center of the search window is set at a position that is substantially proportional to the center of the patch. E.g. where the center of a patch is at 3% of the high-resolution data structure L₁, the center of the search window is set to be at approximately 3% (rounded) of the low-resolution data structure L₀. In this case, for patches near an edge, the search window size may be reduced, or the search window may be shifted completely into the low-resolution data structure L₀.

In general, the larger the search window, the more likely it is to find a very similar patch. However, in practice little difference in accuracy is to be expected by largely increasing the search window, since the local patch structure is more likely to be found only in a very local region in general natural images. Moreover, a larger search window requires more processing during the search.

FIG. 10 shows details of the selection of successive patches in an image (i.e. a 2D input data structure), overlap and the principle of determining a matching block for successive patches. Exemplarily, patches and blocks have 5×5 pixels and search windows have 12×12 pixels (in another embodiment, patches and blocks have 3×3 pixels and search windows have 8×8 pixels or similar). For a first patch P_{1,L1} in L₁, a search window W₁ is determined in L₀, as described above. Within the search window W₁, comparison of the first patch with different blocks is performed, and a block B_{1,L0} is determined that has the least mean absolute difference (MAD). This is the best matching block. Its position within the low-resolution low-frequency data structure L₀ is determined, e.g. its upper left corner being in the third column and second row. Then a corresponding patch at the same position in the high-frequency low-resolution image H₀ is determined. Thus, it is a 5×5 pixel patch with its upper left corner being in the third column and second row. This patch is extracted from H₀ and added to H₁ at the position of the current low-frequency high-resolution patch P_{1,L1}, i.e. at the upper left corner of H₁ (see FIG. 10 a).

The second patch P_{2,L1} is selected according to the employed patch advance, as shown in FIG. 10 b). The patch advance is in this case two pixels in both dimensions, which means that due to the patch size of 5×5 pixels, the overlap is three. Thus, in this example, vertical overlap v, and horizontal overlap vₕ are equal. Due to the slower search window advance, the search window W₂ is the same as for the previous patch. However, due to different pixel values (according to arbitrary image content), another best matching block B_{2,L0} within the search window is found. In the same manner as described above, its position is determined (e.g. upper left corner in the 7^{th} column, 2^{nd} row), the corresponding 5×5 block (with upper left corner in the 7^{th} column, 2^{nd} row) is extracted from H₀, and the extracted block from H₀ is added to the high-frequency high-resolution image H₁ at the position of the second patch P_{2,L1}, i.e. with its upper left corner at the first row, third column. Thus, a particular pixel that belongs to two or more different patches, is accumulated from corresponding pixels of to the best matching blocks. I.e., exemplarily, a particular pixel s in the 4^{th} column, 5^{th} row of the high-resolution high-frequency image H₁ (corresponding to the position in L₁ shown in FIG. 10) has, at the current stage of the process as described, a value that is accumulated from a pixel at the 6^{th} column, 7^{th} row (from the best-matching block B_{1,L0} of the first patch) and from a pixel at the 8^{th} column, 6^{th} row (from the best-matching block B_{2,L0} of the second patch).

As mentioned above, the search window advances usually only after a plurality of patches have been processed. As shown exemplarily in FIG. 10 c) for the Above-described configuration, it takes three patch advances (i.e. the 4^{th} patch) before the search window W₃ is shifted by one pixel in horizontal direction. Further, it is noted here that the sequential order of various dimensions of the patch advance (and thus search window advance) makes no difference. Thus, the patch depicted in FIG. 10 d) may be processed after previous patches have shifted until the right-hand edge of L₁, but it may also be processed directly after the first patch as shown in FIG. 10 a).

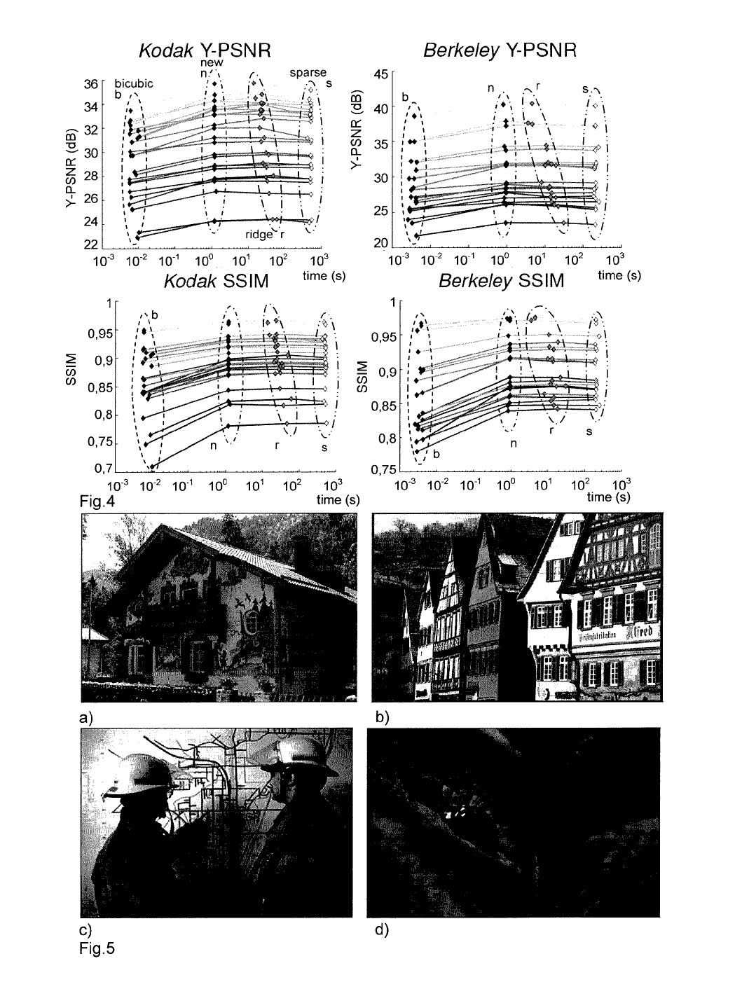

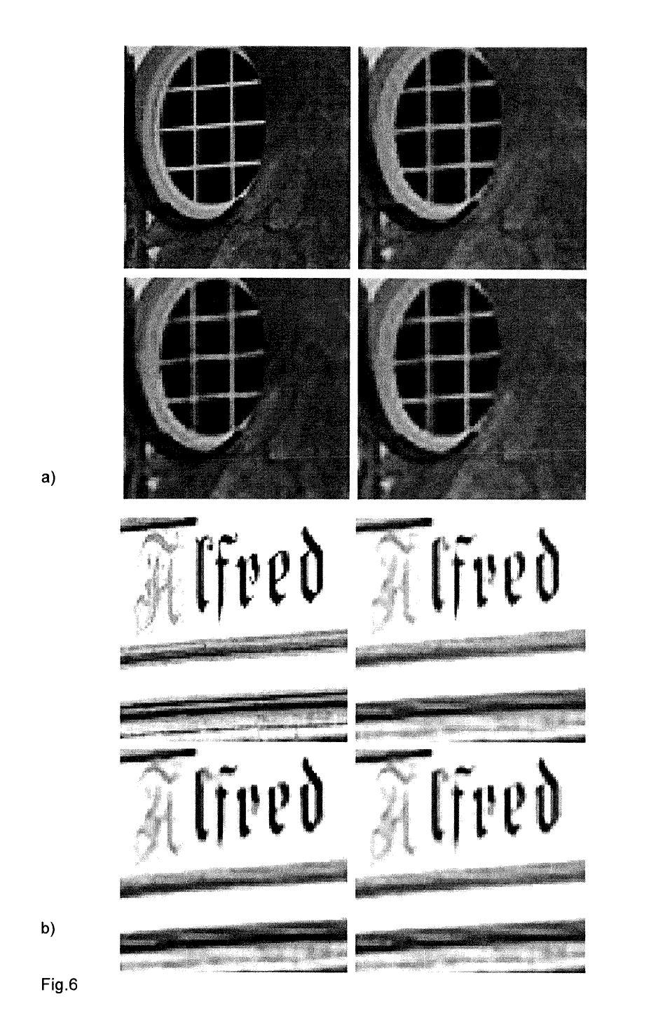

The method was tested using two different datasets. The first one, called “Kodak”, contains 24 images of 768×512 pixels and the second one, called “Berkeley”, contains 20 images of 481×321 pixels that are commonly found in SISR publications. The results were compared to a baseline method (bi-cubic resizing) and two state-of-the-art methods falling in the subcategories of dictionary-based ([8], referred to as “sparse”) and kernel ridge regression ([11], referred to as “ridge”) with a powerful post-processing stage based on the natural image prior. For “sparse”, a dictionary created offline with the default training dataset and parameters supplied by the authors was used. The comparison consists in taking each image from the two datasets, downscaling it by a factor of ½ and up-scaling it by a factor of s=2 with each method. The SSIM, Y-PSNR and execution time were measured. The detailed results are shown in FIG. 4 and the average results for the Kodak and Berkeley datasets are shown in Tables 1 and 2, respectively. In FIG. 4, top, Y-PSNR vs. time for the “Kodak” (left) and “Berkeley” (right) datasets is shown. Bottom, SSIM vs. time is shown. As can be seen, the presently proposed method is the fastest among these SR methods.

TABLE 1
Average results for the “Kodak” dataset

| Method | Time (s) | Y-PSNR (dB) | SSIM |
|---|---|---|---|
| bicubic | 0.007 | 29.10 | 0.86 |
| sparse | 514.7 | 30.53 | 0.89 |
| ridge | 29.13 | 30.81 | 0.90 |
| this invention | 1.193 | 30.68 | 0.89 |

TABLE 2
Average results for the “Berkeley” dataset

| Method | Time (s) | Y-PSNR (dB) | SSIM |
|---|---|---|---|
| bicubic | 0.003 | 28.62 | 0.86 |
| sparse | 208.9 | 30.28 | 0.90 |
| ridge | 13.41 | 30.47 | 0.90 |
| this invention | 0.918 | 30.50 | 0.90 |

All SR methods perform better than the baseline bi-cubic interpolation, as expected, with “ridge” and the method of the present invention also surpassing the dictionary-based method. This reflects the fact that dictionary-based methods do not generalize well in comparison to internal learning. In terms of execution time, the method of the present invention is clearly faster than the other tested sophisticated SR methods, whereas the simple bi-cubic up-scaling algorithm takes a much shorter computing time.

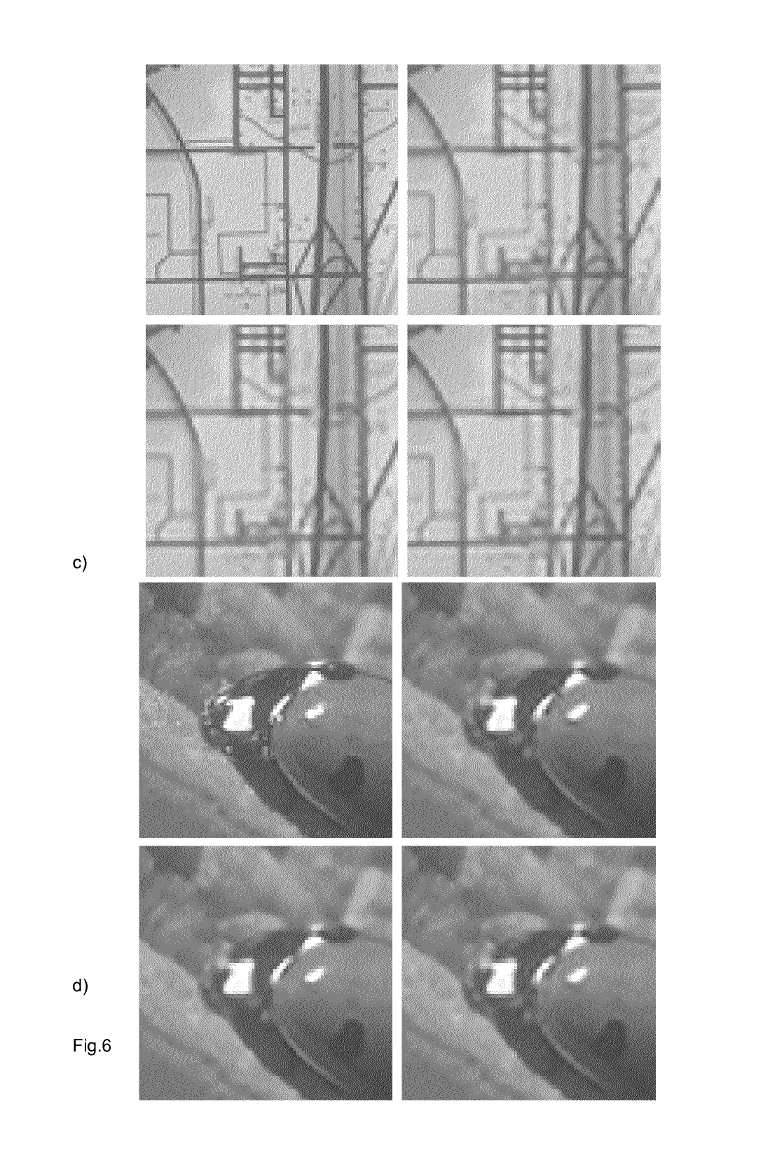

FIG. 5 and FIG. 6 show sample results obtained from both datasets. FIG. 5 shows the original images and FIG. 6 the sample results. FIG. 6 shows sample results from both the Kodak (left) and Berkeley (right) datasets obtained with the presently proposed method. The detail pictures in FIG. 6 show a visual comparison of the groundtruth image (top left), the reconstructed one with the present method (top right), ridge [11] (bottom left) and sparse [8] (bottom right). It is worth mentioning that for these experiments any parameters, such as e.g. the filter selection tuning parameter α and the subset of β roll-off factors for the available filters, were not tuned. This decision responds to our goal of making a fair, more realistic comparison with the other methods, for which no parameters were adjusted.

The above-described single-image super-resolution method is suitable for interactive applications. An advantage is that the execution time is orders of magnitude smaller than that of the compared state-of-the-art methods, with similar Y-PSNR and SSIM measurements to those of the best performing one [11]. The method's execution time is stable with respect to the reconstruction accuracy, whereas [11]'s time increases for the more demanding images. Some key aspects of the proposed method are at least (1) an efficient cross-scale strategy for searching high-frequency examples based on local windows (internal learning) and (2) adaptively selecting the most suitable up-scaling and analysis filters based on matching scores.

In one embodiment, the invention relates to an apparatus for performing super-resolution of single image, wherein a high-resolution version of an observed image is generated by exploiting cross-scale self-similarity. The apparatus comprises at least up-scaling and analysis filters, and an adaptive selection unit for adaptively selecting the up-scaling and analysis filters.

In one embodiment, the adaptive selection unit is adapted for selecting among a plurality of filters with different levels of selectivity.

In one embodiment, the up-scaling and analysis filters are raised cosine filters.

In one embodiment, the up-scaling and analysis filters have parametric kernels, and said adaptive selection unit is adapted for selecting among a plurality of filters with different levels of selectivity.

In one embodiment, the apparatus further comprises a cost measuring unit for measuring a local kernel cost, wherein the adaptive selection unit is adapted for adaptively selecting a filter from among a plurality of filters with different roll-off factors, wherein the adaptively selected filter is the one that provides minimal matching cost for each overlapping patch.

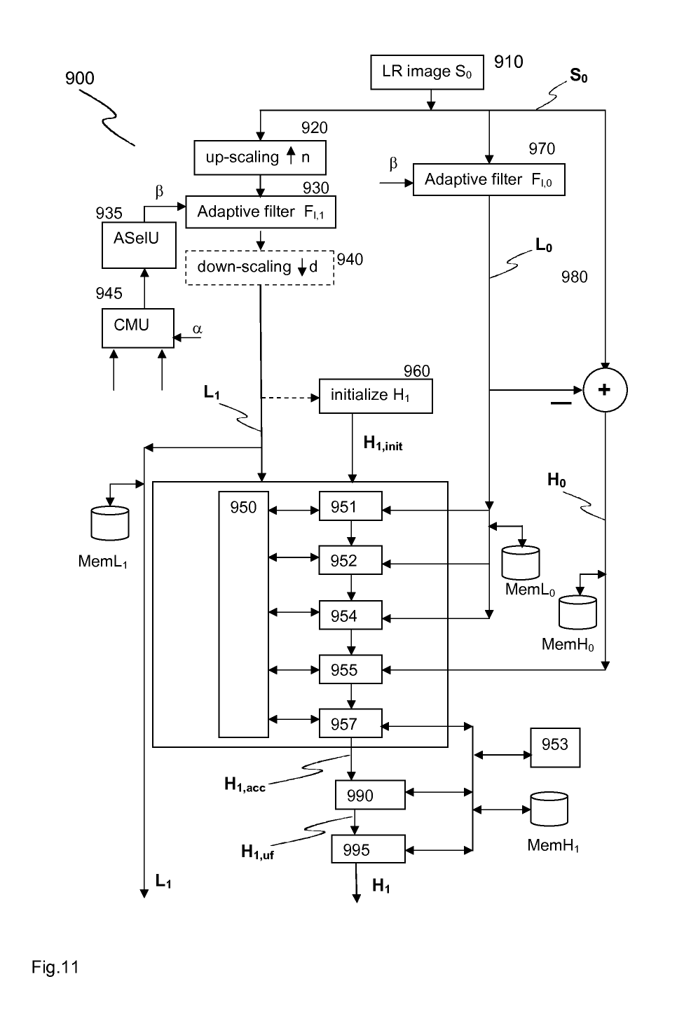

FIG. 11 shows, in one embodiment, an apparatus for performing super-resolution processing of a low resolution input data structure S₀ of digital data, comprising a first adaptive upscaling and analysis filter 970 for filtering the input data structure S₀, wherein a low-frequency input data structure L₀ is obtained, an adder, subtractor or differentiator 980 for calculating a difference between the input data structure S₀ and the low-frequency input data structure L₀, whereby a high-frequency input data structure H₀ is generated, an upscaler 920 for upscaling the input data structure S₀, a second adaptive upscaling and analysis filter 930 for filtering the upscaled input data structure, wherein a low-frequency upscaled data structure L₁ is obtained, a first determining unit 951 for determining in the low-frequency upscaled data structure L₁ a first patch at a first position, a search unit 952 for searching in the low-frequency input data structure L₀ a first block that matches the first patch best, and a second determining 954 unit for determining the position of said first block within the low-frequency input data structure L₀, a selector unit 955 for selecting a second block in the high-frequency input data structure H₀ at the determined position (i.e. at the position that was determined for said first block within the low-frequency input data structure), an accumulator 957 for accumulating (i.e. adding up) pixel data of the selected second block to a second patch, the second patch being a patch in a high-frequency upscaled data structure at the first position that is initially empty, a control unit 950 for controlling repetition of the processing for a plurality of patches in the low-frequency upscaled data structure L₁, a normalizing unit 990 for normalizing (i.e. averaging) the accumulated pixel values in the high-frequency upscaled data structure, whereby a normalized high-frequency upscaled data structure H₁ is obtained, a high-pass filter 995 for filtering the normalized high-frequency upscaled data structure H₁, and a combining unit 999 for combining (e.g. pixel-wise adding) the normalized, high-pass filtered high-frequency upscaled data structure H₁ to the low-frequency upscaled data structure L₁, whereby a super-resolved data structure S₁ is obtained. Various memories MemL₀, MemL₁, MemH₀, MemH₁ with appropriate sizes can be used for intermediate storage, which may however be implemented as one single or more physical memories. In principle, the normalizing (or averaging) comprises, for a current pixel, dividing the accumulated value of the current pixel by the number of pixels that have contributed to the accumulated value of the current pixel. However, any normalizing method that leads to substantially equivalent results can be used.

The apparatus further comprises an adaptive selection unit 935 for selecting or adapting said adaptive upscaling and analysis filter, and a cost measuring unit 945 that, in one embodiment, operates according to eq. (2) and provides control input to the adaptive selection unit 935.

It will be understood that the present invention has been described purely by way of example, and modifications of detail can be made without departing from the scope of the invention.

Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections. Reference numerals appearing in the claims are by way of illustration only and shall have no limiting effect on the scope of the claims.

### CITED REFERENCES

[1] M. Irani and S. Peleg, “Improving resolution by image registration,” CVGIP: Graph. Models Image Processing, vol. 53, no. 3, pp. 231-239,1991.
[2] S. Farsiu, M. D. Robinson, M. Elad, and P. Milanfar, “Fast and robust multiframe super resolution,” IEEE Trans. on Image Processing, vol. 13, no. 10, pp. 1327-1344, 2004.
[3] S. Baker and T. Kanade, “Limits on super-resolution and how to break them,” IEEE Trans. on Pattern Analysis and Machine Intelligence, vol. 24, no. 9, pp. 1167-1183, 2002.
[4] Z. Lin and H.-Y. Shum, “Fundamental limits of reconstruction-based superresolution algorithms under local translation,” IEEE Trans. on Pattern Analysis and Machine Intelligence, vol. 26, no. 1, pp. 83-97, 2004.
[5] W. T. Freeman, E. C. Pasztor, and O. T. Carmichael, “Learning low-level vision,” Int. J. Computer Vision, vol. 40, no. 1, pp. 25-47, 2000.
[6] W. T. Freeman, T. R. Jones, and E. C Pasztor, “Example based super-resolution,” IEEE Comp. Graph. Appl., vol. 22, no. 2, pp. 56-65, 2002.
[7] H. Chang, D. Yeung, and Y. Xiong, “Super-resolution through neighbor embedding,” 2004, pp. 275-282.
[8] J. Yang, J. Wright, T. S. Huang, and Y. Ma, “Image super-resolution via sparse representation,” IEEE Trans. on Image Processing, vol. 19, no. 11, pp. 2861-2873, 2010.
[9] D. Glasner, S. Bagon, and M. Irani, “Super-resolution from a single image,” 2009, pp. 349-356.
[10] M. Bevilacqua, A. Roumy, C. Guillemot, and M.-L. A. Morel, “Neighbor embedding based single-image superresolution using semi-nonnegative matrix factorization,” in IEEE Int. Conf. on Acoustics, Speech and Signal Processing, 2012, pp. 1289-1292.
[11] K. I. Kim and Y. Kwon, “Single-image super-resolution using sparse regression and natural image prior,” IEEE Trans. on Pattern Analysis and Machine Intelligence, vol. 32, no. 6, pp. 1127-1133, 2010.
[12] G. Freedman and R. Fattal, “Image and video up-scaling from local self-examples,” ACM Trans. on Graphics, vol. 30, pp. 12:1-12:11, 2011.
[13] Y. Lin, H. H. Chen, Z. H. Jiang, and H. F. Hsai, “Image resizing with raised cosine pulses,” in Proc. Int. Symposium on Intelligent Signal Processing and Communication Systems, 2004, pp. 581-585.
[14] International Patent Application WO2013/104747 published on 18 Jul. 2013

1-12. (canceled)

13. A method for performing super-resolution of a single image, comprising a step of generating a high-resolution version of an observed image by exploiting cross-scale self-similarity, wherein filters adapted for acting as up-scaling and analysis filters are used, and wherein the up-scaling and analysis filters are adaptively selected from among a plurality of filters with different roll-off factors.

14. The method according to claim 13, wherein a super-resolution version of a single low resolution image is generated, comprising
a. upscaling and low-pass filtering the single low resolution digital input data structure to obtain a low-frequency portion of an upscaled high resolution data structure;
b. separating the low resolution digital input data structure into a low-frequency portion and a high-frequency portion;
c. for each of a plurality of overlapping patches of the low-frequency portion of the upscaled high resolution data structure, performing steps of
d. searching a best matching block in the low-frequency portion of the low resolution digital input data structure;
e. determining its corresponding block in the high-frequency portion of the low resolution digital input data structure; and
f. adding the determined block from the high-frequency portion of the low resolution digital input data structure to the high-frequency portion of the upscaled high resolution data structure, at the position that the above-mentioned patch in the low-frequency portion of the upscaled high resolution data structure has;
and after said steps were performed for each of said plurality of overlapping patches, the method comprising further steps of
g. normalizing and high-pass filtering the resulting high-frequency portion of the upscaled high resolution data structure; and
h. adding the high-pass filtered, normalized high-frequency portion of the upscaled high resolution data structure to the low-frequency portion of the upscaled high resolution data structure, wherein a super-resolution version of the single low resolution digital input data structure is obtained;
wherein said up-scaling and analysis filters are used in the step of upscaling and low-pass filtering the single low resolution digital input data structure, and in the step of separating the low resolution digital input data structure into a low-frequency portion and a high-frequency portion, and wherein the method comprises a further step of adaptively selecting said up-scaling and analysis filters.

15. Method according to claim 13, wherein the up-scaling and analysis filters have parametric kernels, and wherein said step of adaptively selecting said up-scaling and analysis filters comprises selecting among a plurality of filters with different levels of selectivity.

16. Method according to claim 13, further comprising measuring a local kernel cost, wherein the adaptively selected filter is the one that provides minimal matching cost for each overlapping patch.

17. Method according to claim 16, wherein the local kernel cost is measured as
k_{β,i}=α∥x_{β,l,i}−y_{β,l,j}∥₁+(1−α)∥x_{β,h,i}−y_{β,h,i}∥₁.

18. Method according to claim 13, wherein the up-scaling and analysis filters are raised cosine filters.

19. An apparatus for performing super-resolution of single image, wherein a high-resolution version of an observed image is generated by exploiting cross-scale self-similarity, the apparatus comprising filters adapted for acting as up-scaling and analysis filters, wherein the apparatus comprises an adaptive selection unit for adaptively selecting the up-scaling and analysis filters, wherein the adaptive selection unit is adapted for adaptively selecting a filter from among a plurality of filters with different roll-off factors.

20. Apparatus according to claim 19, wherein said adaptive selection unit is adapted for selecting among a plurality of filters with different levels of selectivity.

21. Apparatus according to claim 19, wherein the up-scaling and analysis filters are raised cosine filters.

22. Apparatus according to claim 19, wherein the up-scaling and analysis filters have parametric kernels, and wherein said adaptive selection unit is adapted for selecting among a plurality of filters with different levels of selectivity.

23. Apparatus according to claim 19, further comprising a cost measuring unit for measuring a local kernel cost, wherein the adaptively selected filter is the one that provides minimal matching cost for each overlapping patch.

24. Apparatus according to claim 23, wherein the local kernel cost is measured as
k_{β,i}=α∥x_{β,l,i}−y_{β,l,j}∥₁+(1−α)∥x_{β,h,i}−y_{β,h,i}∥₁.

25. A non-transitory computer-readable storage medium having stored thereon computer-executable instructions that when executed on a computer perform super-resolution of a single image, wherein a high-resolution version of an observed image is generated by exploiting cross-scale self-similarity, and wherein filters adapted for acting as up-scaling and analysis filters are used, and wherein the up-scaling and analysis filters are adaptively selected from among a plurality of filters with different roll-off factors.
